(19) United States
(12) Patent Application Publication
(10) Pub. No.: US 2026/0346960 A1
(43) Pub. Date: Nov. 5, 2026

(54) PENDULUM COUNTERWEIGHT SEMI-SUBMERSIBLE FLOATER FOR OFFSHORE WIND TURBINE AND METHOD OF INSTALLING SAME

(71) Applicant: SAIPEM S.A., Puteaux (FR)

(72) Inventor: Christophe COLMARD, Puteaux (FR)

(21) Appl. No.: 19/488,265

(22) PCT Filed: May 27, 2024
(86) PCT No.: PCT/FR2024/050677

§ 371 Date: Nov. 26, 2025

(30) Foreign Application Priority Data
Jun. 2, 2023 (FR) 2305569

(51) Int. Cl. B63B 35/44; B63B 1/10; B63B 39/02

(52) U.S. Cl. CPC B63B 35/44; B63B 1/107; B63B 39/02; B63B 2035/446

(57) ABSTRACT

A semi-submersible floating structure is equipped with a pendulum counterweight designed for an offshore wind turbine, along with an associated installation method. The float has two tubular structures each including three tubular branches arranged to form a right triangle with a horizontal, a vertical, and a diagonal branch. These frameworks are assembled by their respective vertical branches to create a pylon intended to align with the axis of a wind turbine mast. The tops of the tubular structures, opposite the pylon, are separated by an angle ranging from 25° to 80°.

Additionally, there is a connection tube and a counterweight affixed to the tubular structures at the level of the pylon and at the level of their tops opposite to the pylon. The length of the tendon fixed to the pylon exceeds that of the other two tendons.

### TECHNICAL FIELD

The present invention relates to the general field of semi-submersible floats equipped with a pendulum counterweight for offshore wind turbines. It more specifically concerns a semi-submersible float whose wind turbine support mast is fixed to the periphery of the float, the center of gravity being corrected by a pendulum system.

### PRIOR ART

An offshore wind turbine aims to use wind energy in order to produce electricity using a turbine and an electric generator. There are two main types of offshore wind turbines: the fixed wind turbines which are implanted on the seabed (at shallow depths, typically less than 50 m), and the floating wind turbines which offer the advantage of being able to be built onshore and implanted in areas where the seabed depth typically exceeds 50 m.

The floating wind turbines concerned by the present invention comprise a turbine generally formed by a motor with several rotating blades on a horizontal axis and an electric generator coupled to the motor, the motor and the generator being fixed to an upper end of a vertical mast (or pylon). The lower end of the mast is mounted on a floating support structure.

There are several main families of floating support structures for offshore wind turbines: the semi-submersible floats, the immersed floats with tension legs (or TLP platforms for Tension-Leg Platform), the SPAR-type (for Single Point Anchor Reservoir) floats, the barge-type semi-submersible floats, and the semi-submersible floats with a pendulum counterweight.

The semi-submersible floats constitute the most widely used float model today. They consist of a steel or concrete foundation that generally takes the form of a tripod with three (or four) cylindrical columns connected together by metal structures. The stability of the structure is ensured by a counterweight that allows the immersion of part of the foundation. This structure is characterized by its large size and reduced draft.

The pendulum-type semi-submersible floats typically comprise a counterweight immobilized beneath the float by tendons. This counterweight allows lowering the center of gravity to stabilize the assembly without the need for numerous buoyancy elements at the level of the free surface of the float.

Moreover, the semi-submersible floats generally have their transition piece, that is to say the location where the wind turbine support mast is fixed, at the geometric center of the float in order to provide an optimized buoyancy volume. However, such centering of the mast often makes the access to the wind turbine complicated and requires large-capacity cranes for the installation of the nacelle and of the mast due to the large radius of the required crane.

It is known to use semi-submersible floats with their transition piece at the periphery of the structure in order to greatly simplify access to the wind turbine. However, the hull volume of such floats is most often less well optimized because it is necessary to have a symmetrical compensation in weight and buoyancy on the side opposite to the mast in order to balance the weight of the wind turbine.

### DISCLOSURE OF THE INVENTION

The object of the invention is to propose a semi-submersible float structure which has the advantages of floats with an eccentric transition piece without any of the disadvantages.

In accordance with the invention, this aim is achieved thanks to a semi-submersible float with pendulum counterweight for an offshore wind turbine, comprising:
two tubular structures each comprising three tubular branches forming a right triangle with a horizontal branch, a vertical branch and a diagonal branch, the tubular structures being assembled together by their respective vertical branch to form a pylon intended to be aligned with an axis of a wind turbine mast, the respective tops of the tubular structures which are opposite to the pylon being spaced apart from each other by an angle comprised between 25° and 80°;
a connection tube connecting the horizontal branches or the diagonal branches of the two tubular structures; and
a counterweight fixed by three tendons to the two tubular structures, on the one hand at the level of the pylon, and on the other hand at the level of their tops opposite to the pylon, the length of the tendon fixed to the pylon being greater than the length of the other two tendons so as, in situation, to move the counterweight away from the axis of the wind turbine mast in order to counterbalance the weight of the wind turbine.

The float according to the invention has a transition piece (that is to say the location where the wind turbine support mast is fixed) that is eccentric relative to its geometric center. Such float geometry allows greatly simplifying the access to the wind turbine, in particular for its installation and its maintenance.

Moreover, the invention uses the advantages of the counterweight to stabilize the float by lowering its center of gravity, but also by significantly modifying the center of gravity in the horizontal direction to compensate for the eccentricity of the masses of the mast and of the wind turbine. Thus, the counterweight necessary for the stability is also used to significantly correct the horizontal position of the center of gravity. Since the counterweight is approximately twice as heavy underwater as the weight of the mast and of the nacelle, it is not necessary to shift the counterweight too much to obtain a trim correction.

Furthermore, the float according to the invention has few buoyancy elements on the free surface like the traditional floats with pendulum counterweight, which makes the float almost transparent to the swell, but with a mast located at the periphery of the float like some semi-submersibles, which is very practical for installing the wind turbine and for mooring the float when it is in production phase.

According to one embodiment, the float further comprises a connector comprising an upper platform and a lower platform on which the respective ends of the vertical branches of the two tubular structures are mounted, the platforms being connected together by a vertical tube in order to increase the buoyancy of the pylon.

According to another embodiment, the vertical branches of the two tubular structures form a single piece which is intended to receive the wind turbine mast.

According to yet another embodiment, the float further comprises a lower connector on which the lower ends of the vertical branches of the two tubular structures are mounted in order to ensure their holding and a force absorption, and an upper connector on which upper ends of the vertical branches of the two tubular structures are mounted, the upper connector being intended to receive the wind turbine mast.

Preferably, the three tendons fixed to the counterweight are doubled.

Also preferably, the connection tube is positioned so that it is half immersed during the phase of transport of the float in order to improve its stability.

At least one of the branches of the two tubular structures may be provided with flotation elements.

The connection tube may be fixed to the branches of the two tubular structures by welding or by a pin fixing system.

In one embodiment, the connection tube is fixed to the ends of the horizontal branches or diagonal branches of the two tubular structures which are opposite to the pylon.

Particularly, the connection tube may be fixed to the ends of the diagonal branches of the two tubular structures by being positioned between two vertical tubes mounted at the ends of the diagonal branches.

In another embodiment, the connection tube is fixed to the horizontal branches or to the diagonal branches of the two tubular structures between their respective ends.

In this other embodiment, the tops of the two tubular structures which are opposite to the pylon are advantageously provided with pencil-type flotation buoys.

The object of the invention is also a method for installing a float according to the invention whose connection tube is fixed to the ends of the horizontal branches of the two tubular structures which are opposite to the pylon, the method comprising the towing of the float to its installation site while keeping the floating counterweight in the triangular-shaped area delimited by horizontal branches of the tubular structures and by the connection tube, then the descent of the counterweight beneath the tubular structures.

In this method, during the towing of the float, the floating counterweight can be kept in the triangular-shaped area using towing lines or ballast chains.

Also in this method, when immobilized beneath the tubular structures by the tensioned tendons, the counterweight can be misaligned from the axis of the wind turbine mast and lower the center of gravity of the float, this misalignment making it possible to obtain an overall center of gravity centered horizontally on the overall center of thrust, thus making it possible to stabilize the wind turbine vertically.

The object of the invention is also a method for installing a float according to the invention whose connection tube is fixed to the ends of the horizontal branches of the two tubular structures which are opposite to the pylon, the method comprising the towing of the float to its installation site, followed by the installation of the sinking counterweight by a barge equipped with a crane by descending the counterweight through the triangular-shaped area delimited by the respective horizontal branches of the tubular structures and by the connection tube, the counterweight being previously fixed to the two tubular structures by the tendons.

In this method, the connection tube can be retracted during the installation of the counterweight in order to facilitate its passage through the triangular-shaped area.

The object of the invention is also a method for installing a float according to the invention whose connection tube is fixed to the horizontal branches or to the diagonal branches of the two tubular structures between their respective ends, the method comprising the towing of the float to its installation site, followed by the installation of the sinking counterweight by a barge equipped with a crane or a winch by vertically descending the counterweight outside a triangular-shaped area delimited by the respective horizontal branches of the tubular structures and by the connection tube, the counterweight being previously fixed to the two tubular structures by the tendons.

### BRIEF DESCRIPTION OF THE DRAWINGS

FIG. 1 is a perspective view of a float according to one embodiment of the invention.

FIG. 2 is a perspective view of a float according to another embodiment of the invention.

FIG. 3 is a perspective view of a float according to yet another embodiment of the invention.

FIG. 4 illustrates one implementation of a method for installing the float according to the invention whose connection tube is fixed to the ends of the horizontal branches of the two tubular structures which are opposite to the pylon.

FIG. 5 illustrates one variant of implementation of the method for installing the float according to the invention.

FIG. 6 illustrates another variant of implementation of the method for installing the float according to the invention.

FIG. 7 illustrates one implementation of the method for installing the float according to the invention whose connection tube is fixed between the respective ends of the horizontal branches of the two tubular structures.

FIG. 8 is a perspective view of a float according to yet another embodiment of the invention.

### DESCRIPTION OF THE EMBODIMENTS

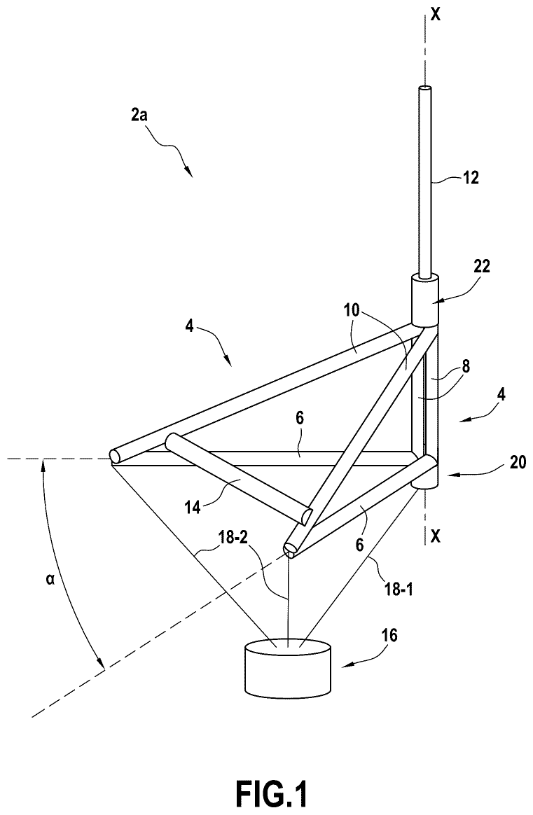

FIG. 1 represents in perspective a semi-submersible float 2a with pendulum counterweight for an offshore wind turbine according to a first embodiment of the invention.

The float 2a according to the invention comprises two identical tubular structures 4 which each comprise three tubular branches forming a right triangle, namely: a horizontal branch 6, a vertical branch 8 and a diagonal branch 10.

The two tubular structures 4 are assembled together by their respective vertical branch 8 to form a pylon intended to be aligned with a vertical axis X-X of the mast 12 of the wind turbine.

In addition, the respective tops of the two tubular structures 4 which are opposite to the pylon are spaced from each other by an angle a comprised between 25° and 80°, and preferably of the order of 40°.

The float 2a according to the invention also comprises a connection tube 14 which connects the respective diagonal branches 10 of the two tubular structures 4 together.

Alternatively, the connection tube could connect the horizontal branches 6 together.

Moreover, the connection tube 14 can be fixed to the ends of the diagonal branches 10 (or horizontal branches) of the two tubular structures which are opposite to the pylon (case of the embodiments of FIGS. 1 to 6) or be fixed to the horizontal branches 6 (or to the diagonal branches) of the two tubular structures between their respective ends (case of the embodiment of FIG. 7).

The fixing of the connection tube 14 to the branches of the tubular structures it connects can be carried out by welding or by a pin fixing system (or pin and hole). With such a pin fixing system, the padeyes are prefabricated but their drilling to pass the fixing pins is carried out during the assembly of the connection tube.

This connection tube 14 not only allows connecting the two tubular structures 4 together but it also acts as a stabilizing float when the counterweight of the float is not yet suspended from the tubular structures (typically during the phases of towing of the float).

The float 2a according to the invention also comprises a counterweight 16 which is fixed by three tendons to the two tubular structures 4: on the one hand at the level of the pylon by a first tendon 18-1, and on the other hand at the level of their tops opposite to the pylon by two other tendons 18-2.

Given the eccentricity of the wind turbine mast 12 relative to the center of gravity of the two tubular structures 4, it is necessary to move the counterweight 16 away from the axis X-X of the mast of the wind turbine to counterbalance the weight of the wind turbine and thus ensure stability of the float. For this purpose, it is provided that the length of the first tendon 18-1 fixed to the pylon is greater than the length of the other two tendons 18-2.

Moreover, in this first embodiment of the invention, the float 2a further comprises a lower connector 20 on which the lower ends of the respective vertical branches 8 of the two tubular structures 4 are mounted, as well as an upper connector 22 on which the upper ends of these vertical branches are mounted.

These lower 20 and upper 22 connectors have the function of ensuring the holding of the tubular structures together, as well as force absorption. In addition, the upper connector 22 is also intended to receive the mast 12 of the wind turbine.

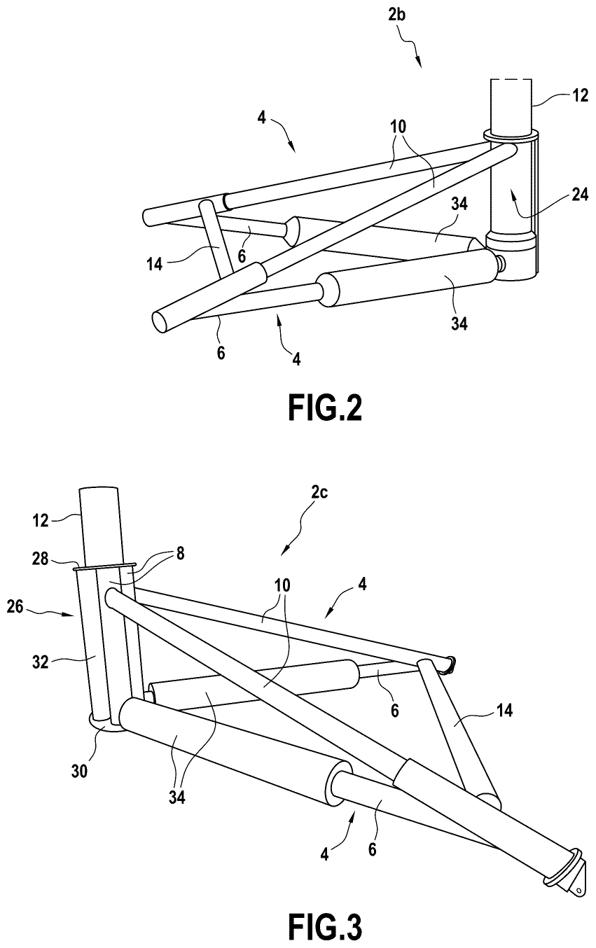

FIG. 2 represents in perspective a semi-submersible float 2b with pendulum counterweight for an offshore wind turbine according to a second embodiment of the invention.

The float 2b according to this embodiment differs from the one previously described in particular by the assembly of the tubular structures 4 together.

Indeed, in this second embodiment, the respective vertical branches of the two tubular structures form a single piece 24 which is intended to receive in its upper part the mast 12 of the wind turbine.

FIG. 3 represents in perspective a semi-submersible float 2c with pendulum counterweight for offshore wind turbine according to a third embodiment of the invention.

The float 2c according to this third embodiment differs from those previously described by the assembly of the tubular structures 4 together.

The float 2c according to this embodiment further comprises a connector 26 formed of an upper platform 28 on which the upper ends of the vertical branches 8 of the two tubular structures are fixed and of a lower platform 30 on which the lower ends of the vertical branches of the two tubular structures are fixed.

Moreover, the platforms 28, 30 of the connector are connected together by a vertical tube 32 making it possible to increase the buoyancy of the pylon.

Regardless of the embodiment, the three tendons 18-1, 18-2 fixed to the counterweight 16 are advantageously doubled in order to increase safety if one of the tendons fails.

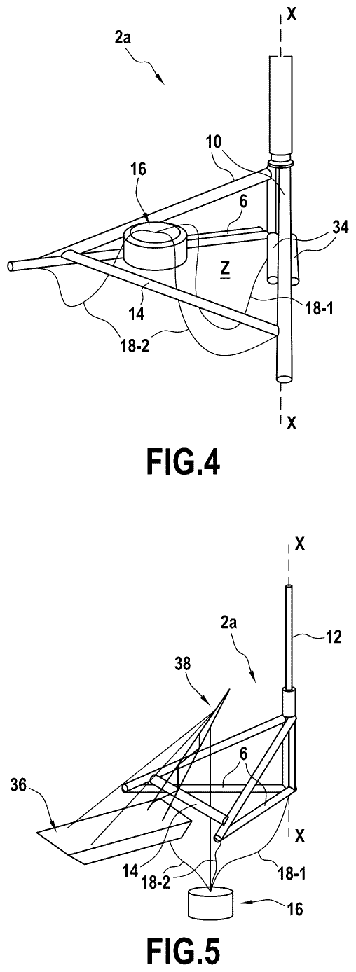

In addition, at least one of the branches of the two tubular structures of the float according to the invention is advantageously provided with flotation elements. Thus, in the embodiments of FIGS. 2 and 3, the respective horizontal branches 6 of the two tubular structures of the float 2b, 2c are each provided with flotation elements 34 (of the buoy type). These flotation elements can wrap the horizontal branch or be fixed on its perimeter as represented in FIG. 4.

In relation to FIG. 4, one mode of implementation of a method for installing the float 2a according to the first embodiment of the invention will be described.

The installation method consists in towing the float 2a to its installation site while keeping the counterweight 16 in a floating state in a triangular-shaped area Z delimited by the two horizontal branches 6 of the tubular structures and by the connection tube 14.

Thus, the counterweight 16 can float inside the float 2a with a large margin. This large margin is necessary to prevent the counterweight from touching the float during towing.

During the towing of the float, the floating counterweight can be kept in this triangular-shaped area using towing lines or ballast chains (not represented in FIG. 4).

It is thus possible to connect the tendons 18-1, 18-2 to the float and to the counterweight 16 in a sheltered location, such as a port, then tow the float to its installation site, and then descend the counterweight beneath the float by ballasting it.

When immobilized beneath the float, the counterweight 16 is misaligned from the axis X-X of the wind turbine mast 12 and lowers the center of gravity of the float, this misalignment making it possible to obtain an overall center of gravity centered horizontally on the overall center of thrust thus making it possible to stabilize the wind turbine vertically.

In relation to FIG. 5, another mode of implementation of the method for installing the float 2a will be described.

In this other embodiment, the float 2a without its counterweight is towed to its installation site. The counterweight 16 is transported in parallel on a barge 36. It is not necessarily floating.

Once it has reached the float installation area, the counterweight 16, in a sinking state and previously fixed to the two tubular structures by the tendons 18-1, 18-2, is descended by a crane 38 mounted on the barge 36 by being passed over the connection tube 14 and then through the triangular-shaped area delimited by the two horizontal branches 6 of the tubular structures and by the connection tube.

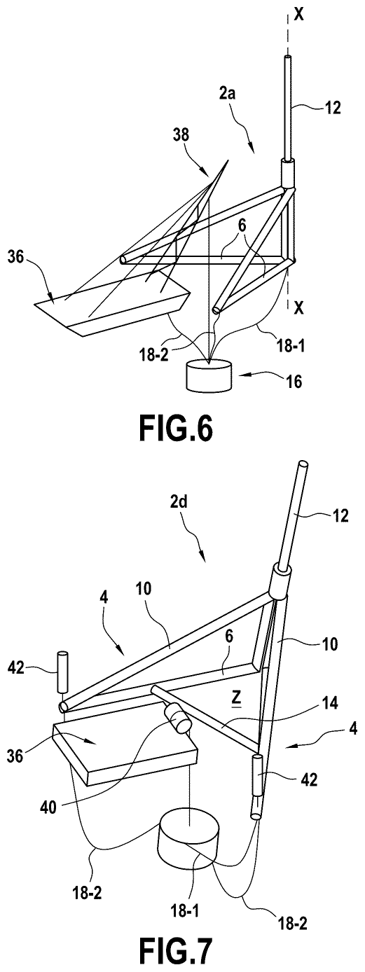

In one variant of the embodiment represented in FIG. 6, the connection tube is retracted during the installation of the counterweight 16 so as to facilitate its passage through the triangular-shaped area.

In relation to FIG. 7, another mode of implementation of the method for installing the float according to the invention will be described.

In this embodiment, the connection tube 14 of the float 2d is fixed to the horizontal branches 6 of the two tubular structures 4 between their respective ends.

This particular arrangement of the connection tube has the advantage that the counterweight 16 of the float can be is descended outside (and not inside) the triangular-shaped area delimited by the two horizontal branches of the tubular structures and by the connection tube.

Thus, this installation method provides for towing the float to its installation site, followed by the installation of the counterweight 16 (in a sinking state) by a barge 36 equipped with a simple winch 40 (or a crane) by vertically descending the counterweight outside the triangular-shaped area Z delimited by the horizontal branches of the tubular structures and by the connection tube.

Prior to its descent, the counterweight 16 is fixed to the two tubular structures of the float by the tendons 18-1, 18-2.

Moreover, in order to improve the stability of the float during its towing, the tops of the two tubular structures 4 which are opposite to the pylon are advantageously equipped with pencil-type flotation buoys 42.

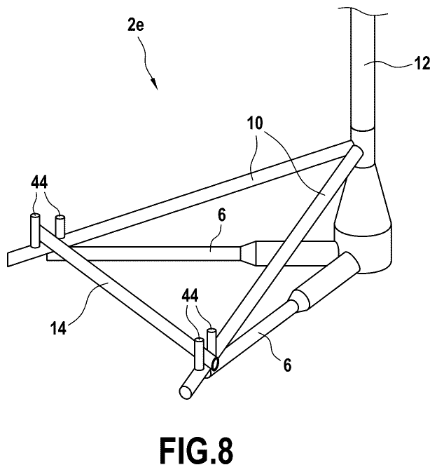

FIG. 8 represents in perspective a semi-submersible float 2e with pendulum counterweight for an offshore wind turbine according to yet another embodiment of the invention.

This embodiment differs from the one described in relation to FIG. 1 in that the connection tube 14 which connects the respective diagonal branches 10 of the two tubular structures together is positioned between two vertical tubes 44 mounted at the ends of the diagonal branches. An additional vertical clamping system (not represented) allows fixing the connection tube 14 to the diagonal branches 10.

These vertical tubes 44 allow simplifying the fixing of the connection tube 14 and significantly increasing the stability of the float in the towing phase.

1.-18. (canceled)

19. A semi-submersible float with pendulum counterweight for an offshore wind turbine, comprising:
two tubular structures each comprising three tubular branches forming a right triangle with a horizontal branch, a vertical branch and a diagonal branch, the tubular structures being assembled together by their respective vertical branch to form a pylon intended to be aligned with an axis of a wind turbine mast, the respective tops of the tubular structures which are opposite to the pylon being spaced apart from each other by an angle comprised between 25° and 80°;
a connection tube connecting the horizontal branches or the diagonal branches of the two tubular structures; and
a counterweight fixed by three tendons to the two tubular structures, on the one hand at the level of the pylon, and on the other hand at the level of their tops opposite to the pylon, the length of the tendon fixed to the pylon being greater than the length of the other two tendons so as, in situation, to move the counterweight away from the axis of the wind turbine mast to counterbalance the weight of the wind turbine.

20. The float according to claim 19, further comprising a connector comprising an upper platform and a lower platform on which the respective ends of the vertical branches of the two tubular structures are mounted, the platforms being connected together by a vertical tube in order to increase the buoyancy of the pylon.

21. The float according to claim 19, wherein the vertical branches of the two tubular structures form a single piece which is intended to receive the wind turbine mast.

22. The float according to claim 19, further comprising a lower connector on which the lower ends of the vertical branches of the two tubular structures are mounted in order to ensure their holding and a force absorption, and an upper connector on which upper ends of the vertical branches of the two tubular structures are mounted, the upper connector being intended to receive the wind turbine mast.

23. The float according to claim 19, wherein the three tendons fixed to the counterweight are doubled.

24. The float according to claim 19, wherein the connection tube is positioned so that it is half-immersed during the phase of transport of the float in order to improve its stability.

25. The float according to claim 19, wherein at least one of the branches of the two tubular structures is provided with flotation elements.

26. The float according to claim 19, wherein the connection tube is fixed to the branches of the two tubular structures by welding or by a pin fixing system.

27. The float according to claim 19, wherein the connection tube is fixed to the ends of the horizontal branches or diagonal branches of the two tubular structures which are opposite to the pylon.

28. The float according to claim 27, wherein the connection tube is fixed to the ends of the diagonal branches of the two tubular structures by being positioned between two vertical tubes mounted at the ends of the diagonal branches.

29. The float according to claim 19, wherein the connection tube is fixed to the horizontal branches or to the diagonal branches of the two tubular structures between their respective ends.

30. The float according to claim 29, wherein the tops of the two tubular structures which are opposite to the pylon are provided with pencil-type flotation buoys.

31. A method for installing a float according to claim 27, comprising the towing of the float to its installation site while keeping the floating counterweight in a triangular-shaped area delimited by the horizontal branches of the tubular structures and by the connection tube, and then the descent of the counterweight beneath the tubular structures.

32. The method according to claim 31, wherein, during the towing of the float, the floating counterweight is kept in the triangular-shaped area using towing lines or ballast chains.

33. The method according to claim 31, wherein, when immobilized beneath the tubular structures, the counterweight is misaligned from the axis of the wind turbine mast and lowers the center of gravity of the float, this misalignment making it possible to obtain an overall center of gravity centered horizontally on the overall center of thrust, thus making it possible to stabilize the wind turbine vertically.

34. A method for installing a float according to claim 27, comprising the towing of the float to its installation site, followed by the installation of the sinking counterweight by a barge equipped with a crane by descending the counterweight through a triangular-shaped area delimited by the respective horizontal branches of the tubular structures and by the connection tube, the counterweight being previously fixed to the two tubular structures by the tendons.

35. The method according to claim 34, wherein the connection tube is retracted during the installation of the counterweight in order to facilitate its passage through the triangular-shaped area.

36. A method for installing a float according to claim 29, comprising the towing of the float to its installation site, followed by the installation of the sinking counterweight by a barge equipped with a crane or a winch by vertically descending the counterweight outside a triangular-shaped area delimited by the respective horizontal branches of the tubular structures and by the connection tube, the counterweight being previously fixed to the two tubular structures by the tendons.
